(19) United States
(12) Patent Application Publication
(10) Pub. No.: US 2011/0038016 A1
(43) Pub. Date: Feb. 17, 2011

(54) IMAGE PROCESSING APPARATUS, IMAGE PROCESSING METHOD, AND IMAGE FORMING APPARATUS

(75) Inventor: Akihisa Nakamura, Kanagawa (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/852,779

(22) Filed: Aug. 9, 2010

Related U.S. Application Data
(60) Provisional application No. 61/232,868, filed on Aug. 11, 2009.

(51) Int. Cl. H04N 1/40

(52) U.S. Cl. 358/448

(57) ABSTRACT

According to one embodiment, an image processing apparatus includes: an image processing section including plural image processing groups and including a DR (dynamic reconfigurable) circuit at least in one of the image processing groups and configured to process image data; a control section configured to set data for reconfiguration in the DR circuit according to content and a processing type of the image data; and a clock supply circuit configured to generate a clock signal supplied to the DR circuit and change a frequency of the clock signal according to the content and the processing type of the image data.

### CROSS-REFERENCE TO RELATED APPLICATION

This application is based upon and claims the priority of U.S. Provisional Application No. 61/232,868, filed on Aug. 11, 2009, the entire contents of which are incorporated herein by reference.

### FIELD

Embodiments described herein relate generally to an image processing apparatus, an image processing method and an image forming apparatus including a dynamic reconfigurable circuit that can change a circuit configuration.

### BACKGROUND

Image forming apparatuses such as an MFP (Multi-Function Peripheral), a color copying machine, and a printer are required to perform high-speed processing. In general, custom LSIs such as an ASIC (Application Specific IC) specialized for image processing are mounted on the image forming apparatuses. Recently, there is a trend for shifting the entire ASIC or a part of the ASIC to a dynamic reconfigurable circuit (hereinafter abbreviated as DR circuit).

The DR circuit includes a limited number of processing elements (hereinafter abbreviated as PEs) arranged in a matrix shape and can freely change the configuration of hardware by changing connection among the PEs. Therefore, the DR circuit can execute various kinds of processing according to purposes. The DR circuit can also change the configuration in the middle of processing. For example, in the MFP, image data read by a scanner section is input to the DR circuit to perform processing of an image.

Since a general DR circuit can switch a function (configuration) by combining PEs, when circuit size is large, plural DR circuits are switched at one clock or the number of clocks close to one clock to cause the DR circuits to perform time division processing. Therefore, when the circuit size increases and an amount of data transfer among image processing blocks including DR circuits increases, the number of switching of areas of circuit elements increases. And leads to deterioration in performance of the DR circuits and deterioration in image processing performance of the MFP.

On the other hand, according to a quality improvement request and the like of customers, high speed and high image quality are required in the MFP. Chip cost increases because of an increase in the size of an image processing circuit, an increase in the size of a memory, and the like. An increase in development cost due to chip development is apprehended. If a FPGA (Field Programmable Gate Array) is used, possible to set a desired image processing function. However, in the FPGA, both circuit size and processing speed are insufficient to perform image processing on a real time basis as in the MFP.

### BRIEF DESCRIPTION OF THE DRAWINGS

FIG. 1 is a diagram of an image forming apparatus according to an embodiment;

FIG. 2 is a block diagram of a circuit configuration of the image forming apparatus according to the embodiment;

FIG. 3 is a specific block diagram of the configuration of an image processing section;

FIG. 4 is a block diagram of a clock supply circuit;

FIG. 5 is a flowchart for explaining the operation of the image processing section;

FIG. 6A is a diagram for explaining a management table for determining a clock frequency; and

FIG. 6B is a circuit diagram for explaining the operation of PLL circuits and selectors.

### DETAILED DESCRIPTION

In general, according to one embodiment, an image processing apparatus includes: an image processing section including plural image processing groups and including a DR circuit at least in one of the image processing groups and configured to process image data; a control section configured to set data for reconfiguration in the DR circuit according to content and a processing type of the image data; and a clock supply circuit configured to generate a clock signal supplied to the DR circuit and change a frequency of the clock signal according to the content and the processing type of the image data.

An image processing apparatus according to an embodiment is explained in detail below with reference to the accompanying drawings. In the figures, the same components are denoted by the same reference numerals and signs.

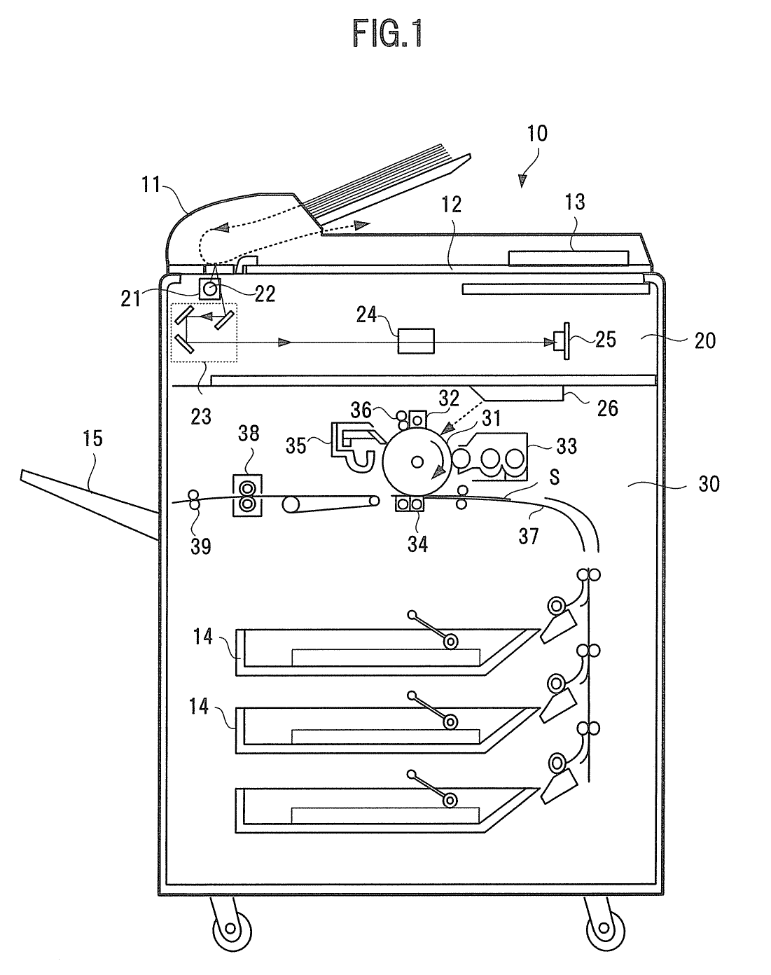

FIG. 1 is a diagram of an image forming apparatus including the image processing apparatus according to the embodiment. In FIG. 1, an image forming apparatus 10 is, for example, an MFP (Multi-Function Peripheral) as a complex machine, a printer, or a copying machine. In the following explanation, the image forming apparatus 10 is explained with the MFP as an example.

The image forming apparatus (MFP) 10 includes, in an upper part thereof, an auto document feeder (ADF) 11, a transparent document table 12, and an operation panel 13. The MFP 10 includes, in a lower part thereof, plural paper feeding devices 14. The MFP 10 includes, on a side thereof, a tray 15 on which sheets are stacked.

Further, the MFP 10 includes a scanner section 20 and a printer section 30. The scanner section 20 reads an image of an original document. The printer section 30 forms an image on a sheet on the basis of read data.

The scanner section 20 includes a carriage 21, an exposure lamp 22, a reflection mirror 23, a lens 24, a CCD (Charge Coupled Device) 25, and a laser unit 26. The scanner section 20 irradiates, in order to scan and read an original document fed by the ADF 11 or an original document placed on the document table 12, light from the exposure lamp 22 provided in the carriage 21 on the original document from below the document table 12 and captures reflected light from the original document into the CCD 25 via the reflection mirror 23 and the lens 24.

Image information captured into the CCD 25 is output as an analog signal. The analog signal is converted into a digital signal and subjected to image processing to generate image data. The image data is supplied to the laser unit 26. The laser unit 26 generates a laser beam according to the image data.

The printer section 30 includes a rotatable photoconductive member 31. Around the photoconductive member 31, a charging device 32, a developing device 33, a transfer device 34, a cleaner 35, and a charge removing lamp 36 are provided along a rotating direction of the photoconductive member 31. The laser beam from the laser unit 26 is irradiated on the photoconductive member 31. An electrostatic latent image corresponding to image information of the original document is formed and born on the outer circumferential surface of the photoconductive member 31.

When image formation is started, the charging device performs discharge in a predetermined discharge position and uniformly charges the outer circumferential surface of the rotating photoconductive member 31 in an axial direction. Subsequently, the laser beam is irradiated on the photoconductive member 31 from the laser unit 26. An electrostatic latent image is formed and born on the outer circumferential surface of the photoconductive member 31.

A developer (e.g., a toner) is provided to the outer circumferential surface of the photoconductive member 31 from the developing device 33. The electrostatic latent image is converted into a toner image and developed. The toner image formed on the outer circumferential surface of the photoconductive member 31 is electrostatically transferred onto a sheet S by the transfer device 34. The sheet S is conveyed from the paper feeding devices 14 through a conveying path 37. The toner remaining on the photoconductive member 31 without being transferred is removed by the cleaner 35 located downstream in the rotating direction of the photoconductive member 31. Thereafter, residual charges on the outer circumferential surface of the photoconductive member 31 are removed by the charge removing lamp 36.

The configuration of the printer section 30 is not limited to the example shown in the figure. Other systems such as a system employing an intermediate transfer belt can also be used. The MFP 10 can also process print data input from a PC (Personal Computer) or the like, output the print data to the printer section 30, and print the print data.

The sheet S having the toner image transferred thereon by the printer section 30 is conveyed to the fixing device 38. The fixing device 38 includes a heating roller and a pressing roller arranged to be opposed to each other. The fixing device 38 causes the sheet S to pass between the heating roller and the pressing roller to fix the toner image, which is transferred on the sheet S, on the sheet S. The sheets on which the toner image fixed and for which the image formation is completed is discharged onto the tray 15 by a paper discharge roller 39.

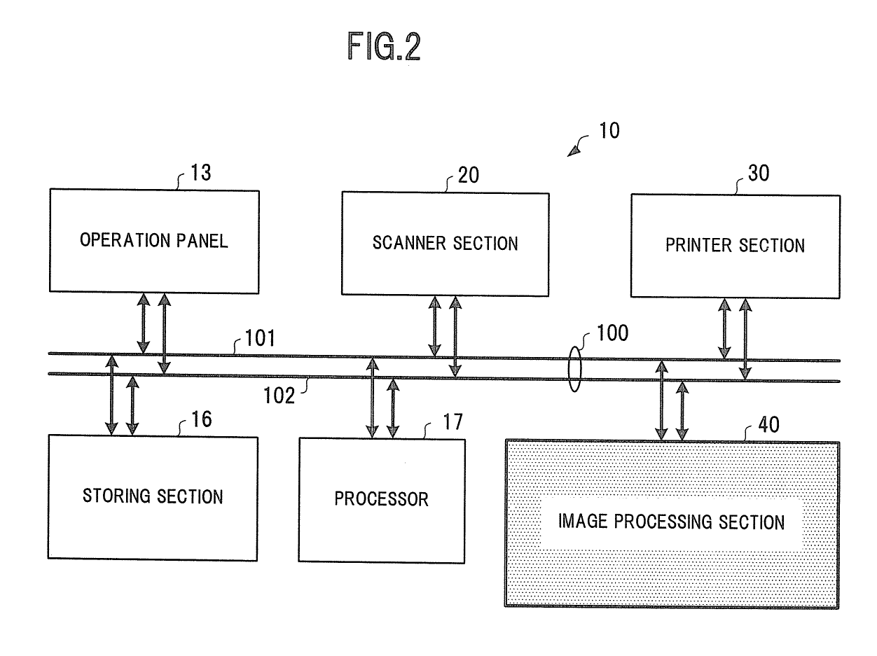

FIG. 2 is a block diagram of a circuit configuration of the image forming apparatus 10 according to the embodiment. The image forming apparatus 10 includes the operation panel 13, a storing section 16, a processor 17, the scanner section 20, the printer section 30, and an image processing section 40. The operation panel 13, the storing section 16, the processor 17, the scanner section 20, the printer section 30, and the image processing section 40 are connected by a PCI bus 100 including a high-speed data bus 101 and a low-speed data bus 102. Various data and control signals are transmitted through the PCI bus 100.

The operation panel 13 includes various operation keys, a display including liquid crystal, and a touch panel integrated with the display. The operation keys are keys for inputting various instructions such as an instruction for the number of prints. The display performs various kinds of display. The storing section 16 includes a storage medium such as a HDD.

The scanner section 20 reads an original document. The image processing section 40 processes image data of the read original document. The image processing section 40 subjects, besides the image data read by the scanner section 20, image data sent from an external PC or the like to compression processing and stores the image data in the storing section 16. The image processing section 40 reads out the image data stored in the storing section 16, applies desired image processing (gradation reproduction, etc.) to the image data, and outputs the image data to the printer section 30.

The processor 17 is a microcomputer including a CPU, a RAM, and a ROM and configures a control section configured to control the operation of the entire MFP 10. For example, the storage of the image data in the storing section 16 and the readout of the image data from the storing section 16 are performed under the control by the processor 17.

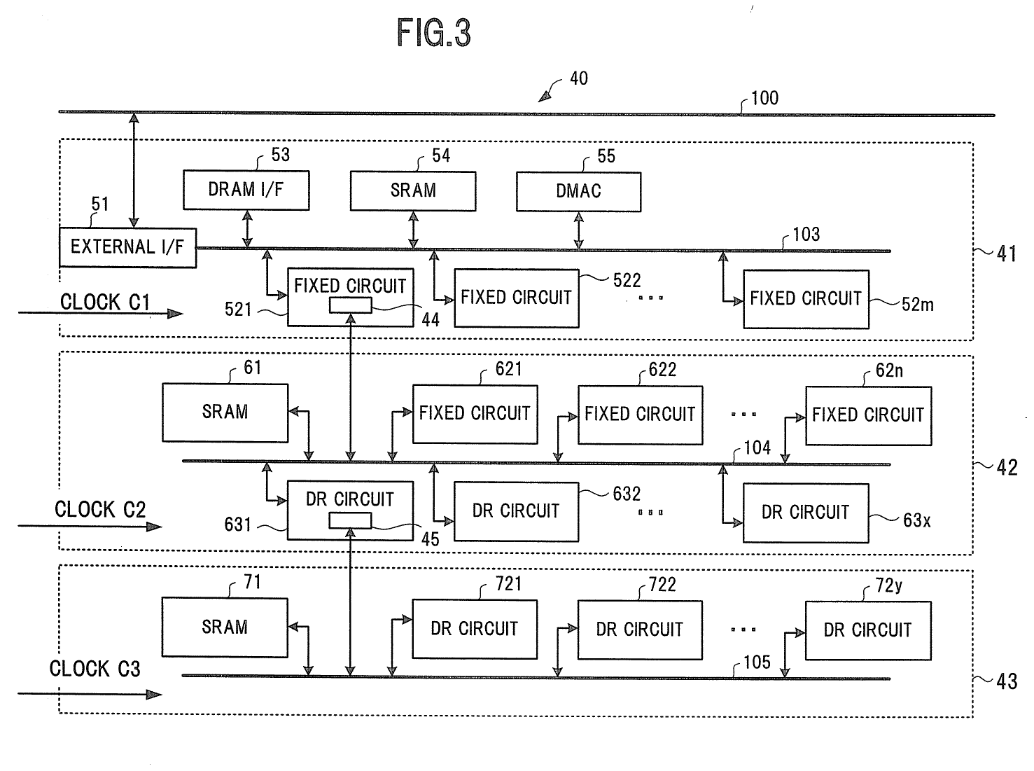

FIG. 3 is a specific block diagram of the configuration of the image processing section 40. As shown in FIG. 3, the image processing section 40 is divided into three image processing groups 41, 42, and 43. The image processing groups 41, 42, and 43 are interconnected through bridges 44 and 45 and configured in a tree structure for performing data transfer among the image processing groups 41, 42, and 43 through the bridges 44 and 45. The bridges 44 and 45 are included in a fixed circuit 521 and a DR circuit 631 explained later.

The first image processing group 41 includes an external interface (I/F) 51 and plural fixed circuits 521, 522, . . . , and 52m. The fixed circuits 521, 522, . . . , and 52m perform image processing set in advance without functions thereof being changed. The first image processing group 41 includes a DRAM interface 53, an SRAM 54 and a DMAC (Direct Memory Access Controller) 55.

The external I/F 51 is connected to the PCI bus 100 and connected to other circuit blocks such as the storing section 16 and the processor 17 of the MFP 10. A bus 103 is connected to the external I/F 51. The plural fixed circuits 521, 522, . . . , and 52m, the DRAM I/F 53, the SRAM 54 and the DMAC 55 are connected to the bus 103.

An external DRAM (Dynamic Random Access Memory) is connected to the DRAM I/F 53. Data processed by the image processing section 40 is stored in the DRAM. The SRAM 54 functions as a line memory. The DMAC 55 is a controller for DMA transfer.

In the second image processing group 42, DR circuits and fixed circuits are mixed. The second image processing group 42 includes an SRAM 61, plural fixed circuits 621, 622, . . . , and 62n, and plural DR (dynamic reconfigurable) circuits 631, 632, . . . , and 63x. The plural fixed circuits 621, 622, . . . , and 62n and the plural DR circuits 631, 632, . . . , and 63x are connected to a bus 104. The SRAM 61 functions as a line memory.

The fixed circuits 621, 622, . . . , and 62n perform image processing set in advance without functions thereof being changed. The DR circuits 631, 632, . . . , and 63x are circuits, functions of which are changed. The second image processing group 42 is a circuit configured to perform minor image processing besides normal image processing.

The third image processing group 43 includes an SRAM 71 and plural DR circuits 721, 722, . . . , and 72y. The DR circuits 721, 722, . . . , and 72y are circuits, functions of which are changed. The DR circuits 721, 722, . . . , and 72y perform complicated image processing in which the functions are highly likely to be changed. The DR circuits 721, 722, . . . , and 72y are connected to a bus 105. The SRAM 71 functions as a line memory.

The fixed circuit 521 and the DR circuit 631 in the image processing groups 42 and 43 respectively include the bridges 44 and 45. The plural image processing groups 41, 42, and 43 are interconnected through the bridges 44 and 45. High-speed data transfer is possible among the circuits in the image processing groups 41, 42, and 43 and among the image processing groups 41, 42, and 43.

Clock signals C1, C2, and C3 are respectively supplied to the image processing groups 41, 42, and 43. Frequencies of the clock signals C1, C2, and C3 supplied to the fixed circuits and the DR circuits in the image processing groups 41, 42, and 43 are changed.

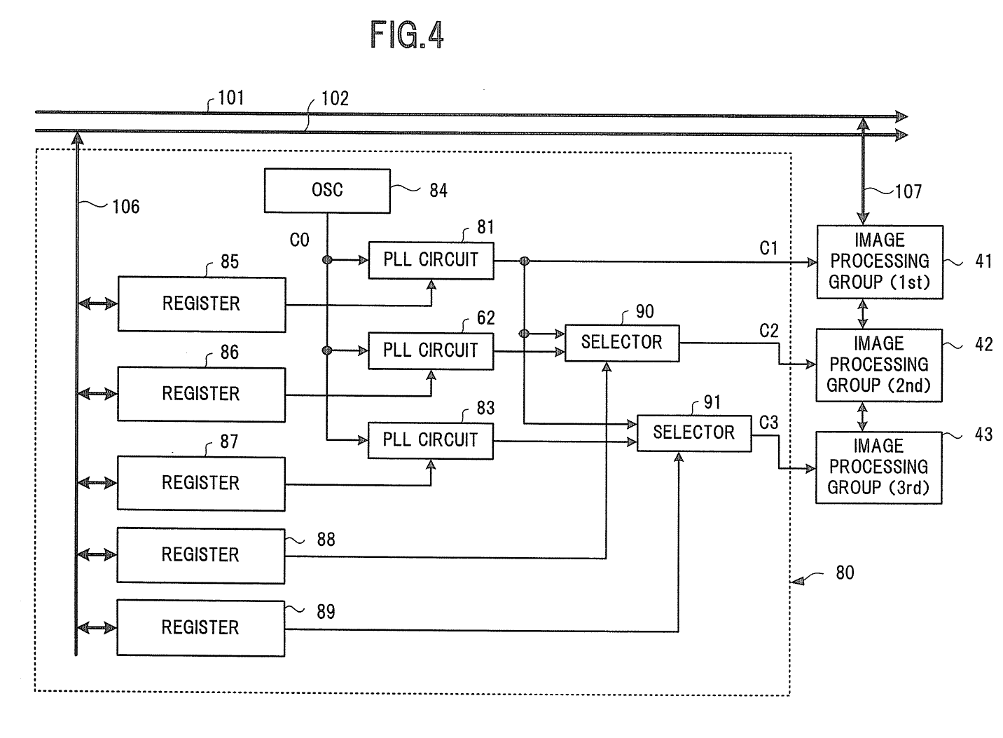

FIG. 4 is a block diagram of a clock supply circuit 80 configured to generate the clock signals C1, C2, and C3 supplied to the image processing groups 41, 42, and 43.

The clock supply circuit 80 includes PLL circuits 81, 82, and 83 and an oscillator 84 configured to supply a basic clock C0 to the PLL circuits 81, 82, and 83. Registers 85, 86, and 87 configured to set multiplication numbers are respectively connected to the PLL circuits 81, 82, and 83. The PLL circuits 81, 82, and 83 can multiply the basic clock C0 from the oscillator 84 with the multiplication numbers set by the registers 85, 86, and 87 and output the basic clock C0.

A clock signal generated by the PLL circuit 81 is supplied to the first image processing group 41 and supplied to selectors 90 and 91. A clock signal generated by the PLL circuit 82 is also supplied to the selector 90. The selector 90 selects the clock signal generated by the PLL circuit 81 or the PLL circuit 82 and supplies the clock signal to the second image processing group 42.

A clock signal generated by the PLL circuit 83 is also supplied to the selector 91. The selector 91 selects the clock signal generated by the PLL circuit 81 or the PLL circuit 83 and supplies the clock signal to the third image processing group 43. Selection operation of the selector 90 and 91 is performed by registers 88 and 89 for clock selection.

The registers 85 to 89 are connected to the low-speed data bus 102 via a bus 106. The first image processing group 41 is connected to the high-speed data bus 101 via a bus 107.

When complicated image processing is performed, even if circuits reconfigured by the plural DR circuits of the image processing groups 42 and 43 increase and plural switching of areas of circuit elements for the circuits are necessary, the clock supply circuit 80 increases a clock frequency to make possible to keep desired performance. Clock frequencies supplied to the respective image processing groups 41, 42, and 43 can be adjusted independently from one another.

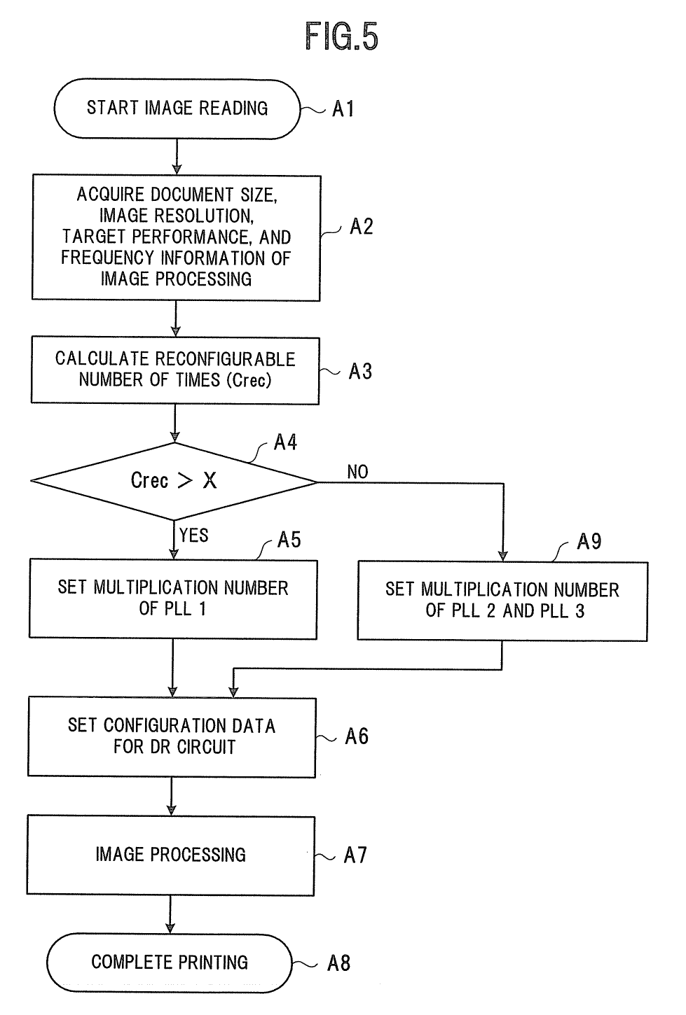

The operation of the image processing section 40 is explained below with reference to a flowchart shown in FIG. 5. The operation shown in FIG. 5 is performed under the control by the processor 17.

Image data processed by the image processing section 40 includes an image mainly including characters and a photograph image. There are various sizes as document sizes. Contents of the image data are various. When the image processing section 40 performs image processing, in some case, for example, high resolution is required for characters. The image processing is performed with edges of the characters changed or the density of the characters changed. A method of the processing is different when the characters are color and when the characters are monochrome. When the photograph image is changed to a thumbnail, compression processing of the image is necessary and processing types of the image data are various. Therefore, important to determine, according to content and a processing type of the image data, in which of the image processing groups 41, 42, and 43 the processing is performed, which of the DR circuits is reconfigured, and to which clock frequency the image processing group is set.

Act A1 in FIG. 5 is a step of starting reading of an image by the scanner section 20. In Act A2, the processor 17 collects a document size and image resolution designated on the operation panel 13. The processor 17 acquires target performance determined in advance and frequency information of image processing. Image size may be automatically detected by using a sensor.

In Act A3, the processor 17 calculates a number of times the DR circuits can be reconfigured (Crec) (hereinafter referred to as reconfigurable number of times). The reconfigurable number of times (Crec) is a value indicating how many times the DR circuits can switch functions in a predetermined time. As the reconfigurable number of times (Crec) is larger, the processing can be performs with a large margin.

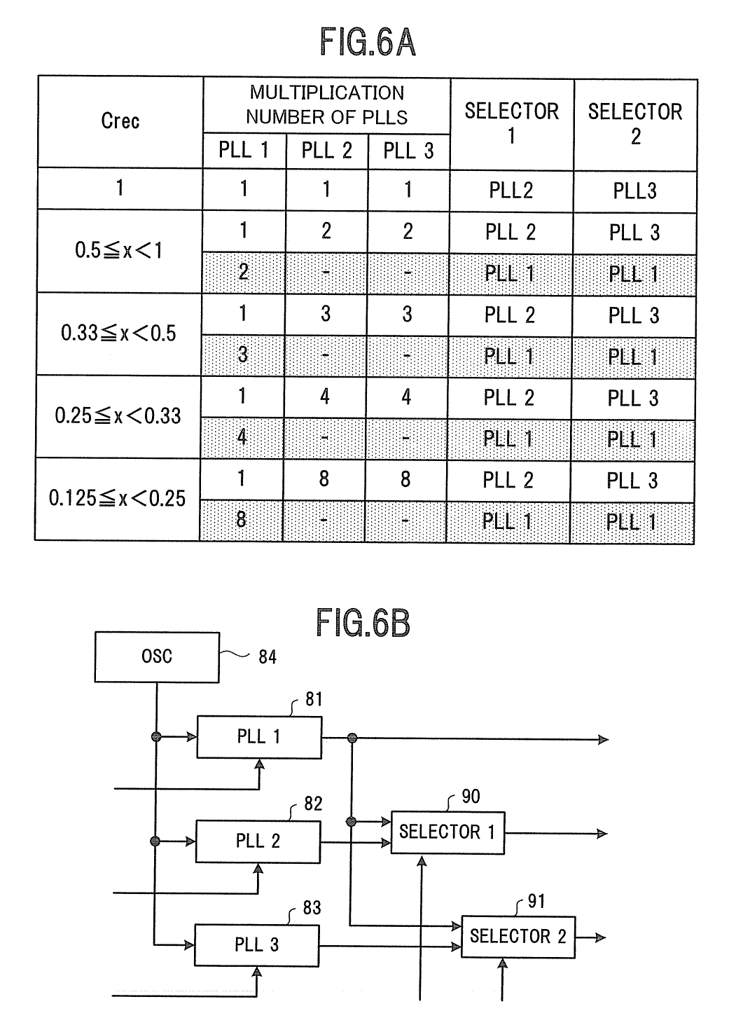

In Act A4, the processor 17 determines whether Crec is larger than x (Crec>x) on the basis of the calculated reconfigurable number of times (Crec). When x=1, if Crec>1, the processor 17 sets a multiplication number of the PLL circuit 81 according to content of a management table (see FIG. 6A) to setting an operating clock frequency (e.g., sets the multiplication number to 1). In Act A6, the processor 17 sets configuration data of the DR circuit of the image processing groups 42 and 43.

The processor 17 sets data in the DR circuits for reconfiguration. The processor 17 sets the configuration data of the DR circuits according to content and a processing type of image data. The data for reconfiguration can be stored in a DRAM connected to the DRAM I/F 53.

In Act A7, the image processing section 40 starts image processing. In Act A8, the printer section 30 performs printing. The setting of the configuration data of the DR circuits is performed under the control by the processor 17 and the functions (the configuration) are switched.

Since the processing can be performed with a larger margin as the reconfigurable number of times (Crec) is larger, when there is a margin, a clock signal with the multiplication number 1 equal to the basic clock is supplied to the image processing groups 41, 42, and 43 to process image data.

On the other hand, if the determination in Act A4 is NO, i.e., Crec≦1, in Act A9, the processor 17 sets multiplication numbers of the PLL circuit 81, 82, and 83 according to the content of the management table (see FIG. 6A). The processor 17 sets reconfiguration data of the DR circuits of the image processing groups 42 and 43, and in Act A7, the image processing section 40 starts the image processing. In Act A8, the printer section 30 performs the printing.

An operating frequency of the DR circuits incorporated in the image processing groups 42 and 43 can be changed by changing a clock frequency. Speed is increased to maximum N-fold speed to switch the reconfigurable number of times of the DR circuits is switched. Therefore, possible to cope with, for example, an increase in image size and keep target performance.

Specifically, if the reconfigurable number of times (Crec) represented by Formula (1) decreases to be equal to or smaller a value set in advance, an internal operating frequency (Fint) supplied to the DR circuits is raised by the PLL circuits. The processor 17 gives setting information concerning multiplication numbers of the PLL circuits 81 to 83 referring to the management table (FIG. 6A).

Crec=Fint/P×L/60(sec) (1)

In Formula (1), Fint represents an internal operating frequency (MHz) of the DR circuits, P represents target performance (cpm), and L represents image size (Mpix).

For example, when the target performance is 600 cpm (copy per minute), the image size is 600 dpi (dot per inch)/A4 (=35 Mpixel), and the internal operating frequency of the DR circuits is set to 200 (MHz), the reconfigurable number of times Crec (number of times) is represented as follows:

200(MHz)/600(cpm)×35(Mpix)/60(sec)=5.7

Crec=5.7 is seen that reconfiguration can be performed five times. And means that the number of operators included in the DR circuits increases by five-fold and the DR circuits can supply a sufficient hardware amount with respect to desired image processing.

On the other hand, when image resolution increases according to a request for image quality improvement or the like, if assumed that the internal operating frequency Fint (MHz) is fixed, a value of Crec decreases as the target performance and the image size increase. Therefore, the reconfigurable number of times Crec is smaller than 1 (Crec<1), likely that a sufficient hardware amount cannot be supplied with respect to desired image processing, and also likely that the target performance cannot be attained.

Therefore, when complicated image processing is necessary according to, for example, the increase in the target performance and the image size, in other words, as content and a processing type of image data become more complicated, the clock frequency is increased to increase the internal operating frequency Fint (MHz) of the DR circuits.

In the clock supply circuit 80 shown in FIG. 4, in order to change an operation clock frequency supplied to the image processing groups 41, 42, and 43, data of multiplication numbers is sent from the processor 17 to the registers 85 to 87 of the PLL circuits 81 to 83 via the low-speed data bus 102 and the bus 106. The PLL circuits 81 to 83 multiply a basic clock signal from the oscillator 84 with multiplication numbers set by the registers 85 to 87.

A clock signal from the PLL circuit 81 is supplied to the image processing group 41. A clock signal from the PLL circuit 81 or 82 is selected by the selector 90 and supplied to the image processing group 42. A clock signal from the PLL circuit 81 or 83 is selected by the selector 91 and supplied to the image processing group 43.

FIG. 6A is a management table for determining a clock frequency. The management table is stored in the storing section 16 shown in FIG. 2 or the like and is referred to when set frequencies (multiplication numbers) of the PLL circuits 81 to 83 are determined. FIG. 6B is a diagram of the PLL circuits 81, 82, and 83 and the selectors 90 and 91 extracted from FIG. 4. In FIGS. 6A and 6B, the PLL circuits 81, 82, and 83 are represented as PLL1, PLL2, and PLL3 and the selectors 90 and 91 are represented as SELECTOR 1 and SELECTOR 2.

For example, when the reconfigurable number of times Crec (=x) is 1 (or larger than 1), multiplication numbers of the PLL circuits 81, 82, and 83 are 1. A clock signal having a frequency same as the basic frequency from the oscillator 84 is output from the PLL circuits 81, 82, and 83. The selectors 90 and 91 respectively select outputs of the PLL circuits 82 and 83. Clock signals having the same frequency are supplied to the image processing groups 41, 42, and 43.

When the reconfigurable number of times is equal to or larger than 0.5 and equal to or smaller than 1 (0.5≦Crec≦1), a multiplication number of the PLL circuit 81 is 1 and multiplication numbers of the PLL circuits 82 and 83 are 2. The selectors 90 and 91 respectively select outputs of the PLL circuits 82 and 83. Therefore, a clock signal multiplied by 1 from the PLL circuit 81 is supplied to the image processing group 41. A clock signal multiplied by 2 from the PLL circuits 82 and 83 is supplied to the image processing groups 42 and 43. Alternatively, also possible that the multiplication number of the PLL circuit 81 is set to 2, the selectors 90 and 91 select an output of the PLL circuit 81, and a clock signal multiplied by 2 from the PLL circuit 81 is supplied to the image processing groups 41, 42, and 43. The multiplication numbers and the selection by the selectors shown in FIG. 6A are determined according to a value of the reconfigurable number of times Crec. The management table shown in FIG. 6A is only an example. The multiplication numbers and the like can be set according to an actual situation.

The management table shown in FIG. 6A can be determined before Act A0 of the image reading shown in FIG. 5 is started. According to a value of the reconfigurable number of times Crec calculated in Act A3, a clock frequency of the PLL circuit 81 to 83 can be updated by the processor 17 every time printing ends.

With the image forming apparatus according to the embodiment, possible to keep, by changing the internal operating frequency of the DR circuits incorporated in the image processing groups, target performance even when complicated image processing is performed, and possible to provide a flexible hardware platform without deteriorating performance.

While certain embodiments have been described, these embodiments have been presented by way of example only, and are not intended to limit the scope of the invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

What is claimed is:

1. An image processing apparatus comprising:
an image processing section including plural image processing groups and including a dynamic reconfigurable circuit at least in one of the image processing groups and configured to process image data;
a control section configured to set data for reconfiguration in the dynamic reconfigurable circuit according to content and a processing type of the image data; and
a clock supply circuit configured to generate a clock signal supplied to the dynamic reconfigurable circuit and change a frequency of the clock signal according to the content and the processing type of the image data.

2. The apparatus of claim 1, wherein the plural image processing group of the image processing section are interconnected through a bridge and configured in a tree structure for performing data transfer among the image processing groups through the bridge.

3. The apparatus of claim 1, wherein
the image processing section includes:
a first image processing group including plural fixed circuit;
a second image processing group including plural fixed circuits and plural dynamic reconfigurable circuits; and
a third image processing group including plural dynamic reconfigurable circuits, and
the clock supply circuit increases a clock frequency supplied to the dynamic reconfigurable circuits in the second and third image processing groups, as the content and the processing type of the image data becomes more complicated.

4. The apparatus of claim 3, wherein the control section calculates, on the basis of the content and the processing type of the image data, a reconfigurable number of times of the dynamic reconfigurable circuits in the second and third image processing groups and increases the frequency of the clock signal when the reconfigurable number of times is equal to or smaller than a value set in advance.

5. The apparatus of claim 3, wherein
the clock supply circuit includes:
plural PLL circuits configured to multiply a basic clock signal;
plural registers configured to set multiplication numbers of the PLL circuits; and
a selector configured to select an output of any one of the plural PLL circuits and supply the output to the first, second, and third image processing groups.

6. The apparatus of claim 5, wherein
the multiplication numbers of the plural PLL circuits and selection operation by the selector are stored in a management table to correspond to the reconfigurable number of times of the dynamic reconfigurable circuit, and
the clock supply circuit determines the multiplication numbers of the PLL circuits and the selection by the selector on the basis of the management table.

7. The apparatus of claim 3, wherein the first image processing group includes an external interface and inputs the image data via the external interface.

8. The apparatus of claim 3, further comprising a DRAM connected to the first image processing group, wherein
data for the reconfiguration and processed image data can be stored in the DRAM.

9. An image processing method comprising:
processing image data with an image processing section including plural image processing groups and including a dynamic reconfigurable circuit in at least one of the image processing groups;
setting data for reconfiguration in the dynamic reconfigurable circuit according to content and a processing type of the image data; and
generating a clock signal supplied to the dynamic reconfigurable circuit with a clock supply circuit, and changing a frequency of the clock signal according to the content and the processing type of the image data.

10. The method of claim 9, wherein the plural image processing group are interconnected through a bridge and configured in a tree structure for performing data transfer among the image processing groups through the bridge.

11. The method of claim 9, wherein
the plural image processing group includes:
a first image processing group including plural fixed circuit;
a second image processing group including plural fixed circuits and plural dynamic reconfigurable circuits; and
a third image processing group including plural dynamic reconfigurable circuits, and
the method further comprises increasing a clock frequency supplied to the dynamic reconfigurable circuits in the second and third image processing groups, as the content and the processing type of the image data becomes more complicated.

12. The method of claim 11, further comprising calculating a reconfigurable number of times of the dynamic reconfigurable circuits in the second and third image processing groups, on the basis of the content and the processing type of the image data, and increasing the frequency of the clock signal when the reconfigurable number of times is equal to or smaller than a value set in advance.

13. The method of claim 11, wherein
the clock supply circuit includes:
plural PLL circuits configured to multiply a basic clock signal;
plural registers configured to set multiplication numbers of the PLL circuits; and
the method further comprises selecting, with a selector, an output of any one of the plural PLL circuits and supplying the output to the first, second, and third image processing groups.

14. The method of claim 13, further comprising:
Storing the multiplication numbers of the plural PLL circuits and selection operation by the selector in a management table to correspond to the reconfigurable number of times of the dynamic reconfigurable circuit; and
determining the multiplication numbers of the PLL circuits and the selection by the selector on the basis of the management table.

15. The method of claim 11, wherein the first image processing group includes an external interface and inputs the image data via the external interface.

16. The method of claim 11, further comprising connecting a DRAM to the first image processing group, and possible to store data for the reconfiguration and processed image data in the DRAM.

17. An image forming apparatus comprising:
a scanner section configured to read an image of an original document;
an image processing section including plural image processing groups and including a dynamic reconfigurable circuit at least in one of the image processing groups and configured to process image data of the original document read by the scanner section;
a control section configured to set data for reconfiguration in the dynamic reconfigurable circuit according to content and a processing type of the image data;
a clock supply circuit configured to generate a clock signal supplied to the dynamic reconfigurable circuit and change a frequency of the clock signal according to the content and the processing type of the image data; and
a printer section configured to print the image data processed by the image processing section.

18. The apparatus of claim 17, wherein the plural image processing group of the image processing section are interconnected through a bridge and configured in a tree structure for performing data transfer among the image processing groups through the bridge.

19. The apparatus of claim 17, wherein
the image processing section includes:
a first image processing group including plural fixed circuit;
a second image processing group including plural fixed circuits and plural dynamic reconfigurable circuits; and
a third image processing group including plural dynamic reconfigurable circuits, and
the clock supply circuit increases a clock frequency supplied to the dynamic reconfigurable circuits in the second and third image processing groups, as the content and the processing type of the image data becomes more complicated.

20. The apparatus of claim 17, wherein
the clock supply circuit includes:
plural PLL circuits configured to multiply a basic clock signal;
plural registers configured to set multiplication numbers of the PLL circuits; and
a selector configured to select an output of any one of the plural PLL circuits and supply the output to the first, second, and third image processing groups.
